(19) United States
(12) Patent Application Publication
(10) Pub. No.: US 2004/0237629 A1
(43) Pub. Date: Dec. 2, 2004

(54) Pressure sensor having a heat shield for use in internal combustion engines

(76) Inventors: Thomas Lenzing, Benningen (DE); Uwe Konzelmann, Asperg (DE)

Correspondence Address: KENYON & KENYON, ONE BROADWAY, NEW YORK, NY, 10004, US

(21) Appl. No.: 10/804,253

(22) Filed: Mar. 19, 2004

(30) Foreign Application Priority Data
Mar. 20, 2003 (DE) 10312491.8-52

(51) Int. Cl. G01L 23/22; G01L 21/12

(52) U.S. Cl. 73/35.12

(57) ABSTRACT

A pressure sensor having a sensor diaphragm for measuring pressure in combustion chambers of internal combustion engines, the pressure sensor being located in a housing, and high pressure and temperature fluctuations occurring in the combustion chamber. A heat shield made of a good heat-conducting material and provided with orifices is placed upstream from the sensor diaphragm to dissipate the heat to the housing surrounding the pressure sensor.

### BACKGROUND INFORMATION

The pressure, among other things, must be measured for regulating the combustion process in internal combustion engines of motor vehicles. This is accomplished by using pressure sensors, among other things, in or on the cylinders of the engine. In addition to regulating the combustion process, the pressure measurement is also used for detecting misfiring and knocking during combustion. Due to the considerable pressure fluctuations and temperature differences which occur in the combustion chamber, the pressure sensors must meet strict requirements.

Due to the high temperatures which occur during combustion in internal combustion engines, conventional pressure sensors such as semiconductor pressure sensors or piezoelectric sensors, for example, are not usable. These sensors do not always withstand the high temperatures in the combustion chamber due to their temperature-sensitive components. For this reason, optical pressure sensors are often used for measuring pressure in internal combustion engines. In these sensors, a light beam is guided to a sensor diaphragm via a light waveguide, preferably a fiber optic waveguide. The back of the sensor diaphragm is reflective. The light is reflected on the reflective side of the sensor diaphragm and guided to a detector. The intensity of the reflected light permits the deformation of the diaphragm, and thus the pressure, to be determined. The diaphragm in this case is directly exposed to the conditions prevailing in the combustion chamber. This means, in particular, that the sudden temperature increase of the flame front incident on the pressure sensor produces a thermal shock error; i.e., the material warpage or stresses occurring in the material due to the temperature gradients are interpreted as pressure. In a more recent design, to protect the diaphragm, a pressure measuring channel having a narrower cross-section, and a deflecting plate are placed upstream from the diaphragm. However, the disadvantage of this design is that, due to the very small geometric dimensions of the pressure measuring channel, oscillating measuring signal interference occurs in the event of rapid pressure changes; in addition, the channel is sensitive to dirt accumulation. Furthermore, in this embodiment, an equalizing damper is placed between the deflecting plate and the sensor diaphragm, which however is susceptible to aging due to the huge temperature and pressure fluctuations. For this reason, its use in a vehicle for a period corresponding to the service life of the internal combustion engine, i.e., a mileage of at least 150,000 km (94,000 mi), cannot be guaranteed.

To ensure reliable operation, the pressure sensor must work reliably in a temperature range of −40° C. to +650° C. and a pressure range of 0 to 200 bar. The temperature fluctuations occur mainly due to weather influences and to the high combustion temperature. In particular, the explosive combustion and the temperature increase produced thereby due to the flame front incident on the sensor diaphragm result in thermal shock errors.

PCT Patent Publication No. WO 97/31251 describes a fiber optic combustion pressure sensor for detecting engine knocking and misfiring. The fiber optic pressure sensor is integrated in a spark plug housing. The pressure is measured in the immediate vicinity of the electrodes which generate the ignition spark. To reduce damage due to heat and material fatigue, the diaphragm has a bowl-shaped design and a non-uniform thickness distribution. The stress on the diaphragm is thus reduced and the operating reliability of the sensor is therefore increased.

### SUMMARY OF THE INVENTION

To reduce the thermal shock error occurring due to the sudden heat effect, a heat shield made of a good heat-conducting material is placed upstream from the sensor diaphragm. To ensure dissipation of the heat flow incident on the heat shield, the heat shield is connected flush to the sensor housing. Thus, it is possible to dissipate the heat flow incident on the heat shield radially to the housing and from there further, for example, to the combustion chamber wall, in which the pressure sensor is located. The heat shield may be placed upstream from the sensor diaphragm in or without contact with the latter. If it is mounted without contact, additional reduction in the thermal shock error is achieved by the fact that the air between the heat shield and the diaphragm acts as an insulator due to its lower thermal conductivity compared to metals. The good thermal conductivity of the heat shield results in most of the incident heat being dissipated radially to the sensor housing.

A pressure measurement is made possible by enabling the pressure to act on the sensor diaphragm through orifices in the heat shield. The orifices in the heat shield may have any desired shape and may be designed with any desired orientation. Thus, for example, slit-shaped orifices positioned in the form of a star are conceivable. The slits may have a triangular, rectangular, trapezoidal, ellipsoidal, or diamond shape. In addition to the star-shaped arrangement of the slits, a peripheral arrangement, for example, is also conceivable. The longitudinal sides of the slits may also have a curvature. In addition to the slit-shaped orifices, orifices in the form of circular bore holes are also conceivable. The bore holes may have any desired arrangement on the heat shield.

Furthermore, the pressure sensor according to the present invention is designed such that it contains no non-metallic components. This means, in particular, that the equalizing damper, such as the one integrated in a pressure sensor according to the related art, is not needed. This results in considerably less aging of the pressure sensor. Furthermore, due to the fact that the pressure measuring channel of the pressure sensor designed according to the present invention may be substantially larger, the pressure sensor is less prone to dirt accumulation, which results in a longer service life.

In addition to directly installing the heat shield at the sensor head, thus bringing the heat shield in direct contact with the flame front occurring during combustion, an additional guard may be placed upstream from the heat shield, which pre-dissipates part of the heat.

### BRIEF DESCRIPTION OF THE DRAWINGS

FIG. 1 shows a cross section through an optical pressure sensor according to the related art.

FIG. 2 shows a head of an optical pressure sensor designed according to the present invention.

FIG. 3 shows a head of an optical pressure sensor designed according to the present invention having an additional heat shield.

FIG. 4 shows a top view of a first embodiment of a heat shield.

FIG. 5 shows a section through a heat shield including heat flow curves.

FIG. 6.1 shows a top view onto the left half of an embodiment of a heat shield having orifices positioned in a star shape.

FIG. 6.2 shows a top view onto the right half of an embodiment of a heat shield having orifices designed as bore holes.

FIG. 7.1 shows a top view onto the left half of an embodiment of a heat shield having tangentially positioned elliptical orifices.

FIG. 7.2 shows a top view onto the right half of an embodiment of a heat shield having triangular slits positioned in a star shape and, between them, radially positioned rectangular slits having curved edges.

### DETAILED DESCRIPTION

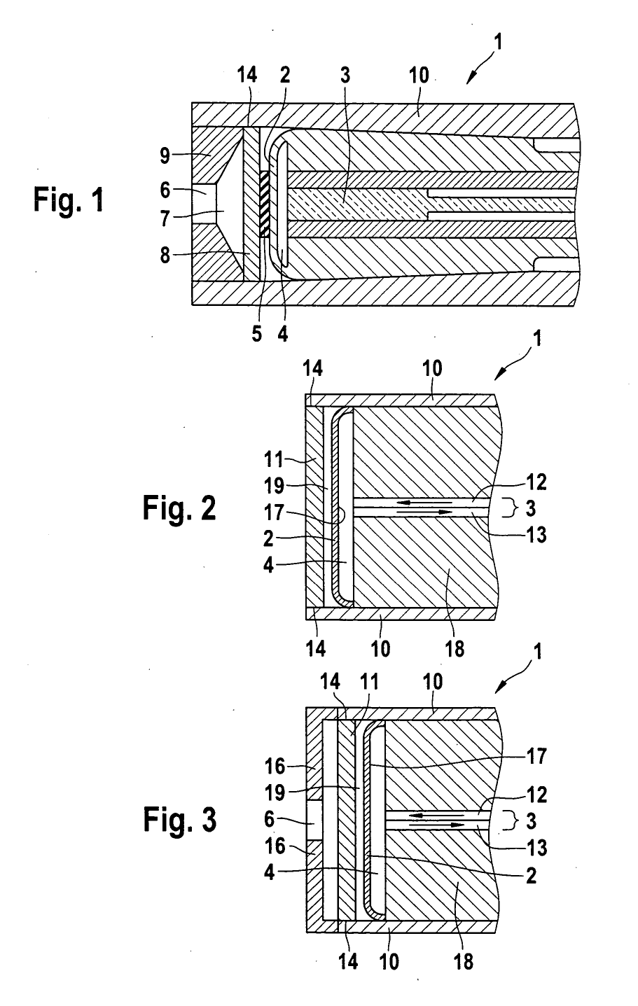

FIG. 1 shows an optical pressure sensor for combustion chambers in internal combustion engines as used in the related art.

The pressure is measured in a pressure sensor 1 operating by an optical measuring principle by reflection of light on the back of a sensor diaphragm 2. For this purpose light is conducted to sensor diaphragm 2 through a light waveguide 3. A cavity 4 is located between the end of light waveguide 3 and sensor diaphragm 2. Light passes through cavity 4 and is reflected on the back of sensor diaphragm 2. The reflected light is received again by light waveguide 3 and conducted to a detector (not shown in the drawing). The pressure is determinable using the intensity of the reflected light, which is directly proportional to the pressure prevailing on the outside of sensor diaphragm 2. Pressure sensor 1 is connected to the combustion chamber (not illustrated), where the pressure is to be measured, via a pressure measuring channel 6.

To protect sensor diaphragm 2 against the flame front formed during combustion and thus against sudden temperature increases, a deflecting plate 8 is located downstream from pressure measuring channel 6. It prevents the flame front from directly impinging on sensor diaphragm 2. To prevent deflecting plate 8 from coming into contact with sensor diaphragm 2 due to a sudden pressure shock, an equalizing damper 5 is located between deflecting plate 8 and sensor diaphragm 2. Equalizing damper 5 has a non-metallic damper mass, which is very susceptible to aging under the conditions prevailing in the combustion chamber. As a result, the robustness of the sensor is insufficient for use in the vehicle over a period corresponding to the service life of an engine, i.e., over 150,000 km. To protect pressure sensor 1 and permit its installation in the combustion chamber, the components required for measurement are located in a housing 10. Housing 10 is sealed on the sensor head by means of a seal 9, in which pressure measuring channel 6 is located. The entire sensor diaphragm 2 is exposed to pressure due to the fact that pressure measuring channel 6 widens via a conical widening 7 to the diameter of sensor diaphragm 2. Deflection plate 8 is installed as an additional heat protection at the point where conical widening 7 has reached the diameter of sensor diaphragm 2. To dissipate the incident heat flow, deflection plate 8 is bonded to housing 10 via a contact point 14. The incident heat is dissipated via contact point 14 to housing 10 and thus to the combustion chamber wall.

FIG. 2 shows the head of a pressure sensor embodied according to the present invention.

To reduce the errors, referred to here as thermal shock errors, caused by a flame front incident on sensor diaphragm 2 of pressure sensor 1, which occur due to the fact that material warpage or stresses generated by the temperature gradient in the material are interpreted as pressure, a heat shield 11 made of a material resistant to the temperatures occurring in the combustion chamber is placed upstream from sensor diaphragm 2. Heat shield 11 preferably has good thermal conductivity. Thus, the heat shield is preferably manufactured of materials having a thermal conductivity of at least 10 W/mK. V2A steel having a thermal conductivity of 21 W/mK, tungsten having a thermal conductivity of 178 W/mK, or titanium having a thermal conductivity of 22 W/mK may be used, for example. Heat shield 11 conducts incident heat flow \dot{Q} (see FIG. 5) via contact points 14 to housing 10. Housing 10 is in direct contact with the combustion chamber wall. The heat incident on pressure sensor 1 is thus transferred to the combustion chamber wall via heat conduction and may be dissipated therefrom. The amount of heat the combustion chamber wall is capable of absorbing depends on the specific heat capacity of the combustion chamber wall. A sensor body 18 having sensor diaphragm 2 mounted on its tip is located in housing 10. Furthermore, light waveguide 3, which ends flush with the head surface of sensor body 18, is located in sensor body 18. To permit deformation of sensor diaphragm 2 when it is exposed to pressure, a cavity 4 is located between sensor diaphragm 2 and sensor body 18 containing light waveguide 3. Light waveguide 3 includes an emitter guide 12, which is connected to a light source, and a detector guide 13, which is connected to a detector. To measure pressure, light is guided from the emitter via emitter guide 12 to the head of sensor body 18. The light is emitted from the tip of emitter guide 12 onto the inside of sensor diaphragm 2, which is designed as a mirror surface 17. Light is reflected from mirror surface 17, received by detector guide 13, and guided to the detector. The pressure is measurable using the intensity of the reflected light, which is directly proportional to the pressure to which sensor diaphragm 2 is exposed. A gap 19, which is used for further buffering of the temperature shocks, is located between sensor diaphragm 2 and heat shield 11. Due to the excellent thermal conductivity of the material of heat shield 11 compared to the gas in the combustion chamber, gap 19 acts as an additional insulator. The heat incident on heat shield 11 is preferably dissipated radially via contact points 14 to housing 10. In contrast, when heat shield 11 is in contact with diaphragm 2, the heat incident on heat shield 11 may also be conducted to sensor diaphragm 2 via the contact points by heat conduction.

In the case of contactless assembly, the heat transport mechanisms between heat shield 11 and sensor diaphragm 2 are radiation and convection. Furthermore, heat is transferred by conduction between heat shield 11 and housing 10 via contact points 14. Due to the higher thermal conductivity of metallic materials compared to gases, most of the heat incident on the heat shield is dissipated to housing 10 via heat conduction. In the case where heat shield 11 and sensor diaphragm 2 are in contact with one another, the heat transport mechanism between sensor diaphragm 2 and heat shield 11 is also heat conduction. As a result, most of the heat is dissipated to sensor diaphragm 2 due to the smaller thickness of heat shield 11 compared to its diameter, and from there it is conducted further to housing 10 and sensor body 18. In the case of contact assembly, the accumulation of heat in the heat shield also results in only part of the heat being transferred to the sensor diaphragm thus reducing the thermal shock error.

FIG. 3 shows the head of a pressure sensor embodied according to the present invention, together with the additional heat shield guard.

The design and function of pressure sensor 1 illustrated in FIG. 3 largely correspond to those of pressure sensor 1 illustrated in FIG. 2. Unlike pressure sensor 1 illustrated in FIG. 2, pressure sensor 1 illustrated in FIG. 3 contains a guard 16 mounted upstream from heat shield 11. Guard 16 has a pressure measuring channel 6 in its center. The advantage of guard 16 thus mounted upstream from the head of pressure sensor 1 is that part of the heat of the incident flame front is pre-dissipated via guard 16. A further portion of the incident heat is then dissipated via heat shield 11. The thermal shock error due to the suddenly occurring high temperatures may thus be further reduced.

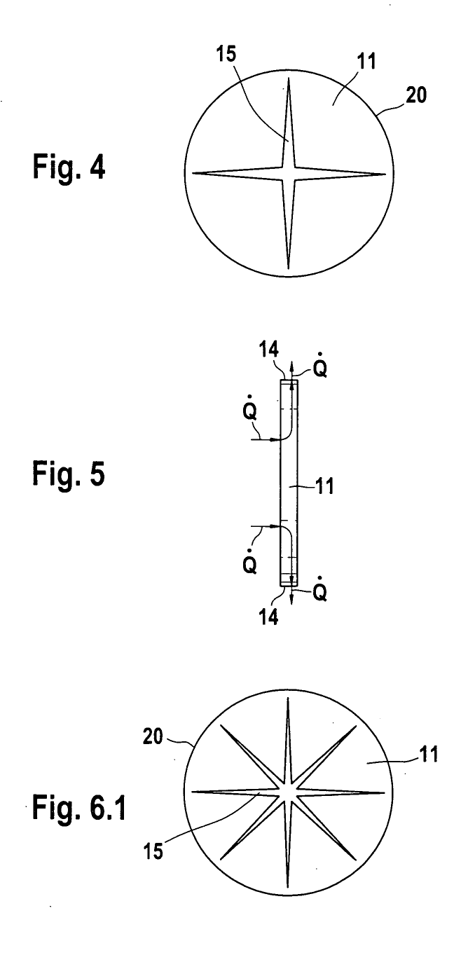

FIG. 4 shows a first embodiment of a heat shield designed according to the present invention.

Heat shield 11 designed according to the present invention and illustrated in FIG. 4 contains two orifices 15, which are designed as diamond-shaped slits intersecting in the center at a 90° angle. Orifices 15 in heat shield 11 ensure that the pressure between heat shield 11 and sensor diaphragm 2 is the same as that in the combustion chamber. Uniform dissipation of heat is ensured by the fact that an edge 20 of heat shield 11 has a direct contact with housing 10 of pressure sensor 1 throughout. The heat is thus dissipated uniformly in the radial direction via edge 20, which simultaneously forms contact point 14 with housing 10.

FIG. 5 shows heat flow \dot{Q} incident on heat shield 11 to contact point 14 with housing 10. Due to the good thermal conductivity of heat shield 11, incident heat flow \dot{Q} is deflected in the heat shield and transported radially to contact point 14 with housing 10. Heat flow \dot{Q} is then transferred here to housing 10 and may be dissipated therefrom.

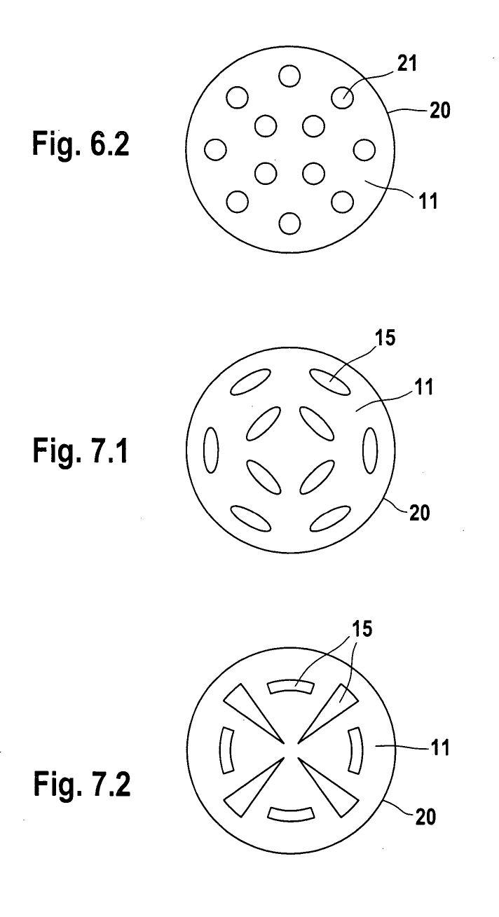

FIG. 6.1 shows a second embodiment of heat shield 11. In heat shield 11 illustrated in FIG. 6.1 orifices 15 are positioned in a star shape.

FIG. 6.2 shows the right half of a heat shield 11 embodied according to the present invention, in which orifices 15 are designed as bore holes 21. In the embodiment illustrated in FIG. 6.2, bore holes 21 are positioned concentrically around the center of heat shield 11. In addition to the concentric arrangement, however, any other arrangement of bore holes 21 is conceivable.

FIG. 7.1 shows an embodiment of heat shield 11, in which orifices 15 have an elliptical shape. Elliptical orifices 15 are positioned tangentially on heat shield 11. FIG. 7.2 shows a further embodiment of a heat shield 11 designed according to the present invention. The embodiment illustrated in FIG. 7.2 includes orifices 15 having a triangular cross-section, which are positioned in a star shape, and, between them, orifices 15 having a rectangular cross-section with two curved sides, positioned tangentially.

In addition to the embodiments illustrated in FIGS. 4, 6.1, 6.2, 7.1, and 7.2, other embodiments are also conceivable. Thus, for example, orifices 15 may be designed as slits having a polygonal cross-section and at least three sides, or an ellipsoidal cross-section. Polygonal orifices 15 having at least three sides may have straight or curved lateral surfaces. In addition to the radial arrangement illustrated, the slits may also be positioned tangentially.

To produce orifices 15 in heat shield 11, various manufacturing methods may be used. Thus, orifices 15 may be produced by stamping, erosion, or cutting, for example.

### Reference Symbols

1 pressure sensor

2 sensor diaphragm

3 light waveguide

4 cavity

5 equalizing damper

6 pressure measuring channel

7 conical widening

8 deflection plate

9 seal

10 housing

11 heat shield

12 emitter guide

13 detector guide

14 contact point

15 orifice

16 guard

17 mirror surface

18 sensor body

19 gap

20 edge

21 bore holes

\dot{Q} heat flow

What is claimed is:

1. A pressure sensor comprising:
a housing surrounding the pressure sensor;
a sensor diaphragm for measuring pressure in at least one combustion chamber of an internal combustion engine, high pressure and temperature fluctuations occurring in the combustion chamber; and
a heat shield composed of a heat-conducting material, the heat shield having orifices, the heat shield being situated upstream from the sensor diaphragm to dissipate heat to the housing surrounding the pressure sensor.

2. The pressure sensor according to claim 1, wherein the orifices in the heat shield have a desired cross-section.

3. The pressure sensor according to claim 1, wherein the orifices in the heat shield are designed as slits in a desired orientation.

4. The pressure sensor according to claim 3, wherein the slits have the form of at least one of (a) a polygon having at least three sides, the sides being one of straight and curved, and (b) an ellipsoid.

5. The pressure sensor according to claim 3, wherein the orifices, designed as slits, are situated in a star shape.

6. The pressure sensor according to claim 3, wherein the orifices, designed as slits, are situated tangentially.

7. The pressure sensor according to claim 1, wherein the orifices are bore holes.

8. The pressure sensor according to claim 1, further comprising an additional guard having a pressure measuring channel situated upstream from the heat shield.

9. The pressure sensor according to claim 1, wherein the heat shield is in contact with the sensor diaphragm.

10. The pressure sensor according to claim 1, wherein the heat shield is not in contact with the sensor diaphragm.

11. The pressure sensor according to claim 1, wherein the heat shield is composed of a material that is resistant to temperatures in the combustion chamber.

12. The pressure sensor according to claim 1, wherein the heat shield is composed of a good heat-conducting material.

13. The pressure sensor according to claim 1, wherein the pressure sensor is used in the combustion chamber of the internal combustion engine in a motor vehicle to reduce a thermal shock error.
